(19) United States
(12) Patent Application Publication
(10) Pub. No.: US 2011/0127354 A1
(43) Pub. Date: Jun. 2, 2011

(54) DEVICE FOR FOAMING AND DELIVERY OF LIQUIDS

(76) Inventor: Mercedes Sanchez Cubero, Selzach (CH)

(21) Appl. No.: 12/787,430

(22) Filed: May 26, 2010

(30) Foreign Application Priority Data
May 29, 2009 (EP) 09161482.6

(51) Int. Cl. B05B 7/26

(52) U.S. Cl. 239/310

(57) ABSTRACT

A device is provided for foaming and delivery of liquids and includes a housing in which a fluid reservoir having the liquids to be foamed is provided, a propellant reservoir for delivery of a propellant, and a dispensing mechanism for dispensing the foamed liquids. A first part of the propellant can be transported out of the propellant reservoir through a first conduit to the fluid reservoir such that the liquid to be foamed can be conveyed out of the fluid reservoir and introduced into a mixing unit, wherein a second part of the propellant can be introduced directly out of the propellant reservoir into the mixing unit through a second conduit. The liquids conveyed out of the fluid reservoir into the mixing device by the propellant can be foamed.

### BACKGROUND AND SUMMARY

The present invention relates to a device for foaming and delivery of liquids. The present invention relates especially to a device for foaming and dispensing liquids comprising a housing in which a fluid reservoir having the liquid to be foamed is provided, a propellant reservoir for delivering a pressurizing agent, and a dispensing mechanism for dispensing the foamed liquids.

A device of this type is especially suitable for foaming and delivering liquid dairy cream (also known as pouring cream), it can, however, obviously be used for other foamable liquids or near-liquid media as well. In general, in this application, the term “liquid” is understood to mean a substance, or a mixture of substances, whose shape can be relatively easily altered through the application of external pressure, whereas a change in volume (especially a reduction in volume) is only possible through the application of extremely high pressures.

Devices for foaming and delivery of liquids having the design described above are known. They are often used in the home or in gastronomic establishments, for example, for processing liquid cream (pouring cream) into whipped cream, or for foaming sauces, desserts, etc., so that they have the desired consistency.

The mechanics of the majority of such devices are basically relatively simple. Thus, for example, the liquids to be foamed are initially poured into a fluid reservoir which is then closed. Subsequently, a pressurizing agent (for example a compressed air-gas mixture) is introduced out of a suitable propellant reservoir into the fluid reservoir such that the liquid to be foamed together with the propellant is then conveyed out of the fluid reservoir by the corresponding increase in pressure in the interior of the fluid reservoir. Subsequently, the mixture of the liquid to be foamed is mixed with propellant in a so-called mixing device so as to give the liquid a foamy consistency. The foamed liquid is then taken from the outlet of the mixing device and used.

There also exist, however, devices which have a more complicated design, for example, in that various fluid reservoirs are provided so that various liquids can be used in parallel or simultaneously. Cooling and/or heating means can also be provided to bring the liquid to be dispensed to a desired temperature prior to discharge.

A disadvantage with these known devices for foaming and delivery of liquids, however, is that their use usually involves a direct contact between the liquid to be foamed and the propellant. Due to this contact, the ideal conditions are created in the fluid reservoir for the development of bacteria and other microorganisms which cause spoilage in the liquid after a relatively short time. This is especially true when compressed air is used as the propellant. For this reason, the liquids to be foamed in conventional devices must be consumed within a relatively short time after the first use.

Still more complex devices also exist already, in which the liquid to be foamed is sucked by a pump out of the fluid reservoir and then pressurised. However, these devices have the disadvantage that the liquid in the fluid reservoir is contaminated by the ambient air, thereby rendering the liquid unusable in the same way as described above. Additionally, such devices are relatively bulky and depend on an active power supply. Therefore they are not suitable for sporadic use, or for use outdoors.

Documents U.S. Pat. No. 4,318,443 and U.S. Pat. No. 5,238,155 disclose devices which generate and dispense foamed liquids. In these devices, the propellant is fed through two conduits so that a first part pushes the liquid to be foamed out of the fluid reservoir and into the foaming module, while a second part of the propellant is introduced directly into the foaming module.

WO2008/055845 proposes a method and a device for frothing liquid foods in which the foamy form of the liquid is generated by turbulent flow. The foam is thus not generated in the interior of the device, but during the exit out of the same and upon contact with the air.

However, a disadvantage of the devices for foaming and delivery of liquids described above is that the amount of propellant required cannot be regulated. The use of these devices is therefore also not optimal.

It is therefore desirable to propose a new device for foaming and delivery of liquids, which does not have the disadvantages of the prior art. It is especially desirable to provide a device for foaming and delivery of liquids, in which device the liquids to be foamed can be used problem-free over a longer period of time without the danger, as described above, that the liquids could spoil and thus become unusable, and in which device compressed air in particular is used as a propellant. The device should also be of compact construction, and should also not depend on external energy sources. Finally, the consistency of the foam should be freely adjustable.

According to an aspect of the present invention, a device for foaming and delivery of liquids is provided comprising a housing, in which a fluid reservoir with the liquid to be foamed is provided, a propellant reservoir for delivering a propellant, and a dispensing mechanism for dispensing the foamed liquid, in which device a first part of the propellant can be transported out of the propellant reservoir through a first conduit to the fluid reservoir such that the liquid to be foamed can be conveyed out of the fluid reservoir and introduced into a mixing device, a second part of the propellant can be introduced directly out of the propellant reservoir into the mixing device through a second conduit, and the liquids conveyed out of the fluid reservoir into the mixing device by means of the propellant can be foamed, a control mechanism being provided by means of which the relative proportion between the first part of the propellant and the second part of the propellant can be adjusted.

An advantage available through an aspect of the invention lies in particular in that the liquid to be foamed during the use of the inventive device comes into contact with the propellant only after being conveyed out of the fluid reservoir. Thus, only the amount of liquid actually required is ever “contaminated” by the propellant, thus leaving the not-required liquid untouched. In this way, a much longer shelf life of the liquids can be achieved. Additionally, by this means a qualitative and quantitative control of the foaming is also achieved. In fact, the optimal mixing ratio between the liquid to be foamed and the required propellant depends on the consistency of the liquid to be foamed and on the characteristics of the propellant itself. Due to the control mechanism, it can be guaranteed that the mixing ratio for each liquid can be optimally adjusted so that an optimal foaming result can also be achieved.

In an aspect of the present invention, a release mechanism is provided by means of which the release of the propellant out of the propellant reservoir can be actuated. This aspect has, among others, the advantage that the release of the propellant can be controlled as required so that propellant is then only released out of the propellant reservoir when liquids are actually to be foamed. By this means in particular, an uncontrolled release of the propellant is prevented.

In a further aspect of the present invention, the propellant reservoir is arranged removably on the housing and is connected via a pressure delivery mechanism to the housing. This aspect has the particular advantage that different propellants can be used very easily. Thus a first propellant reservoir having a first propellant can be easily removed and replaced by a second propellant reservoir having a second propellant, without the need for disassembling the entire device. Due to the built-in pressure delivery mechanism, undesired leakage of propellant out of the propellant reservoir can also be prevented during these operations. Finally, an empty propellant reservoir can very easily be replaced by a new propellant reservoir.

In yet another aspect of the present invention, the fluid reservoir is formed by the housing, wherein a piston is provided in the interior of the housing, which piston can be actuated by the first part of the propellant such that the liquid to be foamed is conveyed out of the reservoir. This aspect has the particular advantage that the liquid to be foamed can be directly introduced into the housing so that the entire device can be as simply and easily constructed as possible. Since the propellant and the mixing device are constructed as separate elements (or modules), and since it is not possible to mix the propellant with the liquid in the fluid reservoir, the liquid can also be left for a longer period of time in the housing without becoming unusable.

In an aspect of the present invention, the fluid reservoir is arranged removably in the interior of the housing and is connected via a transition valve to the mixing device. This aspect has the particular advantage that the fluid reservoir can be easily removed and replaced. For example, the fluid reservoir can be removed and stored in a refrigerator or cooler during longer periods of non-use. In this way, the shelf life of the liquid used can also be further extended. Additionally, this type of fluid reservoir having a first liquid (or a first liquid mixture) can be removed and replaced by a second fluid reservoir having a second liquid. A device according to this aspect of the invention also permits very easy maintenance because the majority of parts do not come into any contact with the liquid to be foamed, and also because the device can be disassembled relatively easily in order to get to the contaminated parts.

In another aspect of the present invention, the fluid reservoir is designed as a flexible fluid bag. The particular advantage of this aspect lies in that the bags require relatively little space and can additionally be relatively easily compressed by the propellant. This is advantageous, for example, when the bags are to be stored in a refrigerator when they are not being used. These fluid bags can be manufactured for example from a flexible synthetic material. In this way, it is also possible to avoid adding to the weight of the device. Furthermore, disposal of the used bag is very simple and requires no special arrangements. Naturally, however, other materials are also conceivable.

In yet another aspect of the present invention, the flexible fluid bag is made from a synthetic material. The advantage of this aspect lies particularly in that the physical and mechanical characteristics of synthetic materials are especially suited for use as a fluid reservoir. Synthetic materials are also relatively cost efficient, resulting in an advantageous price for the device as a whole. Last but not least, bags made from synthetic material are very robust, which substantially simplifies the manipulation of filled bags.

In yet another additional aspect of the present invention, the fluid reservoir is designed as a rigid container, wherein a piston is provided in the interior of the container, which piston can be actuated by the first part of the propellant such that the liquid to be foamed is conveyed out of the container. This aspect especially has the advantage that a rigid container is even more robust than a flexible bag. Due to the integrated piston, the delivery of the liquid to be foamed can still be very easily realized without sacrificing the advantages of easy removal and handling.

In a further aspect of the present invention, a locking mechanism is provided, during the opening of which the housing can be disassembled and reassembled during the locking of the same. As stated above, the advantage of this aspect lies especially in the fact that the device can be disassembled and reassembled as needed. In combination with a removable fluid reservoir, this has the substantial advantage that not-used liquids can be stored in a refrigerator or the like in a very space-saving manner until the next use.

In a further aspect of the present invention, the propellant is compressed air. This aspect especially has the advantage that many liquids can only be foamed especially well by compressed air to give the desired consistency of the end product. However, other propellants (air-gas mixtures) are often used with conventional devices, which makes the liquid to be foamed very quickly unusable after it has been contaminated by air. Thus, an optimal consistency of the end product can now be combined with a long shelf life at the same time.

Finally, in a further aspect of the present invention, the dispensing mechanism comprises a lever and/or a push button and/or a nozzle actuation by means of which the delivery of the foamed liquid can be controlled. This aspect has the particular advantage that the delivery of the foamed liquid can be easily and precisely controlled. The device according to this aspect of the invention is thus also especially suited for delivering foamed liquids directly for use, without first having to pour the liquids into other serving or dispensing devices.

### BRIEF DESCRIPTION OF THE DRAWINGS

The embodiments of the present invention will be subsequently described by way of examples. The examples of the embodiments will be illustrated by the following attached figures:

FIG. 1 shows a schematic cross section representation of a device for foaming and delivery of liquids according to a first embodiment of the present invention;

FIG. 2 shows schematically the device from FIG. 1 in an exploded view, i.e. as if the device were disassembled;

FIG. 3 shows schematically the device from FIGS. 1 and 2 in which the first phase of the assembly (installation of the fluid reservoir) is shown;

FIG. 4 shows schematically the device from FIGS. 1 to 3 in which the last phase of the assembly (installation of the propellant reservoir) is shown;

FIG. 5 shows a schematic cross section representation of a device for foaming and delivery of liquids according to a second embodiment of the present invention.

FIG. 6 shows a schematic cross section representation of a device for foaming and delivery of liquids according to a third embodiment of the present invention.

### DETAILED DESCRIPTION

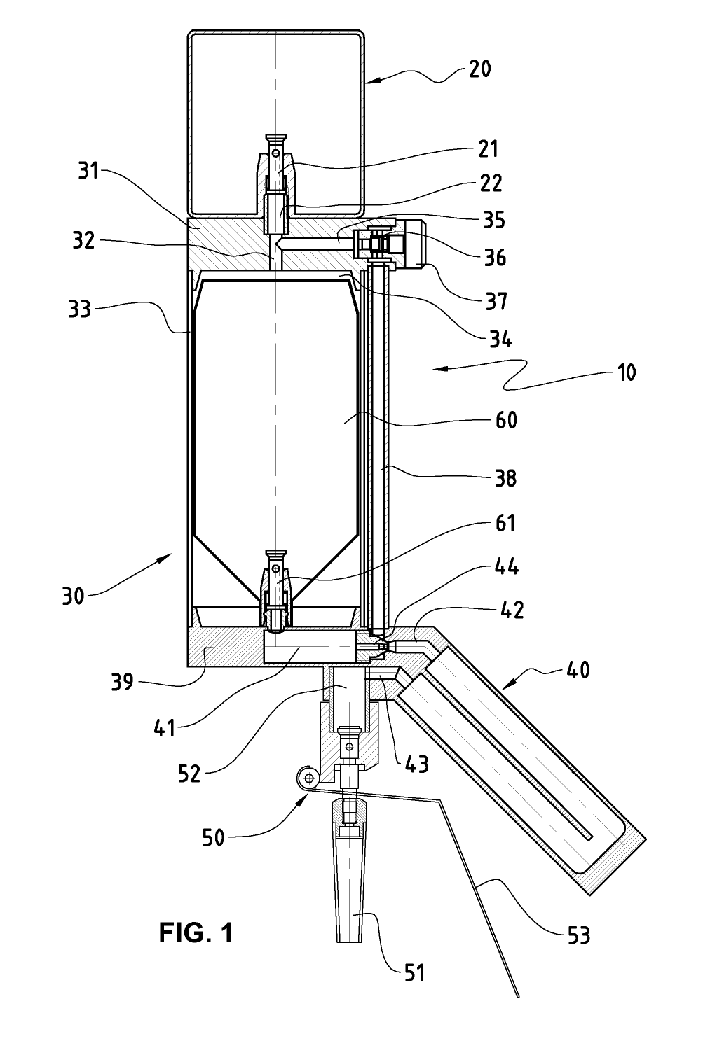

FIG. 1 shows a device 10 for foaming and delivery of liquids according to a first aspect of the present invention. In FIG. 1, reference sign 20 relates to the propellant reservoir, reference sign 30 to a housing in which a fluid reservoir 60 having liquids to be foamed is located, and reference sign 50 relates to a dispensing mechanism for dispensing the foamed liquids.

The propellant reservoir 20 can for example be a conventional propellant reservoir. It is, however, also easily conceivable to provide a special propellant reservoir 20 for this device 10. The propellant reservoir 20 is connected to the housing 30 via a pressure delivery mechanism 21, 22. The pressure delivery mechanism 21, 22 can for example comprise a standard check valve 21 and the appertaining centering tube 22. Naturally, however, other similar realizations are also conceivable for the pressure delivery mechanism.

The propellant reservoir 20 is arranged removably on the housing 30 and can be very easily replaced. In this way, the device 10 can be provided with different propellants, which propellants can be installed as required. An empty propellant reservoir 20 can thus also be easily replaced by a full one. Fastening means (not shown) can be provided to fasten the propellant reservoir 20 to the housing 30 so that the necessary, stability can be assured.

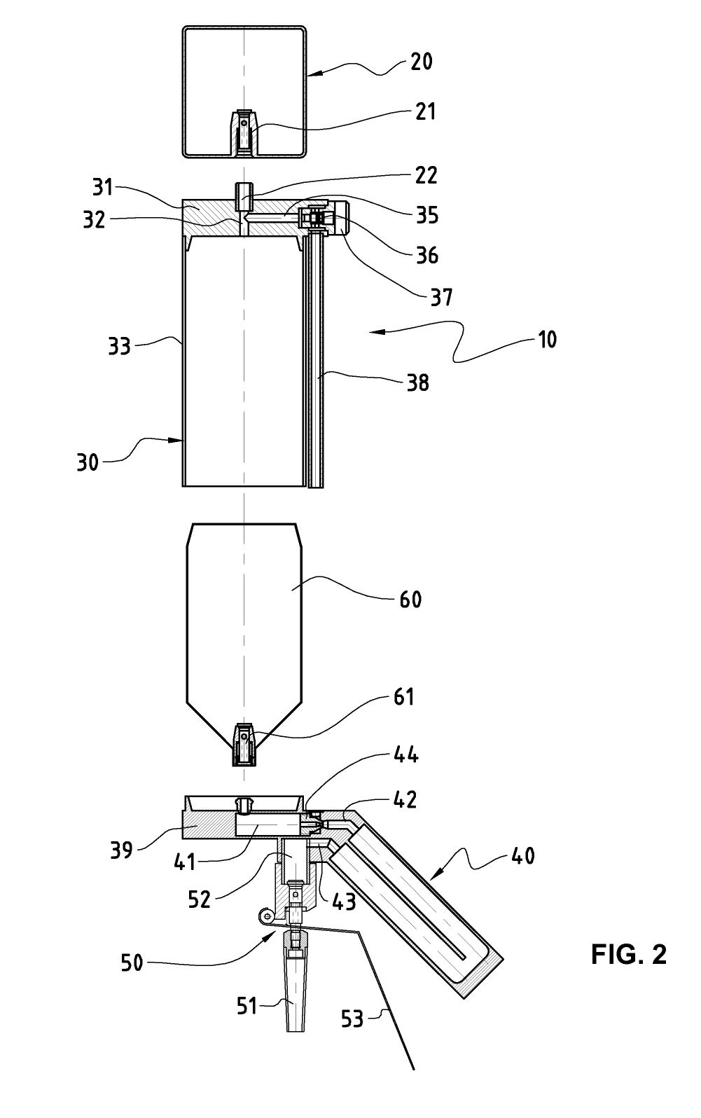

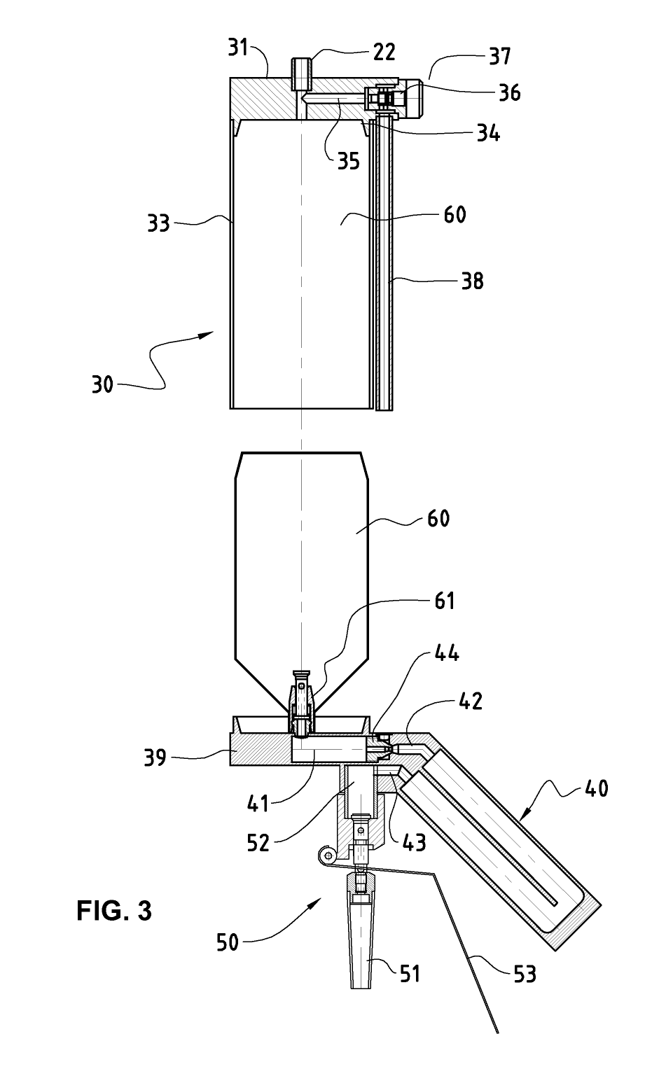

The housing 30 in turn comprises various elements 31, 33, 39 which can be connected to each other and fastened by means of a locking mechanism (not shown) so as to achieve a compact device 10. In particular, the housing 30 comprises a cover 31 in which the centering tube 22 is integrated, and to which the propellant reservoir 20 is fastened, a wall 33 which forms the middle part of the housing 30, and a base 39 which is connected to the mixing device 40 and the dispensing mechanism 50. These individual housing elements 31, 33, 39 can be seen even more clearly in FIGS. 2 and 3, because the device 10 is shown here in each case in an exploded view.

A first conduit 32 and a second conduit 35, which are provided to conduct the propellant out of the propellant reservoir 20, are located in the cover 31 of housing 30. Thus, the first conduit 32 connects the propellant reservoir 20 to the interior 34 of the housing 30 in which the fluid reservoir 60 is located. The second conduit 35 on the other hand connects the propellant reservoir 20 to the mixing device 40.

A release mechanism (not shown) and a control mechanism 36, 37 are likewise located in the cover 31 of housing 30. This release mechanism and this control mechanism can be designed as a unit. Even so, it is clear to any person skilled in the art that it can also be two completely separate units and the invention should therefore not be limited to the solution in which these two functions are joined in one single device. Thus, by means of this release mechanism, the release of the propellant out of the propellant reservoir 20 can be activated and deactivated.

The control mechanism 36, 37 serves at the same time to enable the adjustment of the relative proportion between the first part of the propellant (which is supplied via the first conduit 32 to the housing interior 34) and the second part of the propellant (which is supplied via the second conduit 35 directly to the mixing device). Thus, the relative proportion between the propellant and the liquid to be foamed in the mixing unit can also be indirectly regulated. As described above, the relative proportion between the propellant and the liquid to be foamed in the mixing unit is essential for achieving an optimal consistency of the end product.

In FIG. 1, the control mechanism 36, 37 comprises in particular a variable valve 36 which can be controlled by means of a knob 37. This variable valve 36 can then be opened, for example by pressing on the knob 37, after adjusting the desired mixing ratio thereby allowing the propellant to flow out of the propellant reservoir 20, into the first conduit 32 and into the second conduit 35.

The second conduit 35 continues through a second section 38 which conducts the second part of the propellant directly into the mixing device 40, i.e. into the inlet conduit 42 of the mixing device 40. In the mixing device 40, this second part of the propellant is subsequently mixed with the liquid to be foamed which was conveyed out of the fluid reservoir 60 by the first part of the propellant and then conducted via a transition valve 61, a storage chamber 41 and a mixing valve 44 similarly into the input conduit 42 of the mixing device 40. As already mentioned, the relative proportions of the first and the second parts of the propellant are adjusted by the control mechanism 36, 37 depending on the liquid to be foamed, so that an optimal foaming can be ensured.

After foaming, the foamed liquids leave the mixing device 40 via an outlet conduit 43 and arrive in the dispensing mechanism 50. This dispensing mechanism 50 comprises for example a lever 53, which can be actuated to cause the dispensing of the foamed liquids via the outlet conduit 51. It is naturally obvious to every person skilled in the art that the dispensing mechanism 50 can also be realized in many different ways (for example with a push button or a nozzle actuation) and that the version shown is only one of these various options.

The first part of the propellant is conveyed, after discharge out of the propellant reservoir 20, through the first conduit 32 to the interior 34 of the housing 30. The fluid reservoir 60 is located in the interior 34, the reservoir being constructed in FIG. 1 as a flexible synthetic material bag. As just described, this fluid reservoir 60 is connected via the transition valve 61, the storage chamber 41 and a mixing valve 44 to the mixing device 40 so that the liquid located in the fluid reservoir 60 can be conveyed to the mixing device 40.

The flow of propellant into the interior 34 of the housing 30 causes the pressure therein to increase significantly such that the increase in pressure results in forces on the fluid reservoir 60. These forces cause the volume of the fluid reservoir 60 to decrease so that the liquids located therein are conveyed out of the fluid reservoir 60 and into the mixing device 40 as described above. However, no contamination by the propellant of the liquid remaining in the fluid reservoir 60 takes place. The liquids conveyed out are then foamed and made available for delivery via the dispensing mechanism 50.

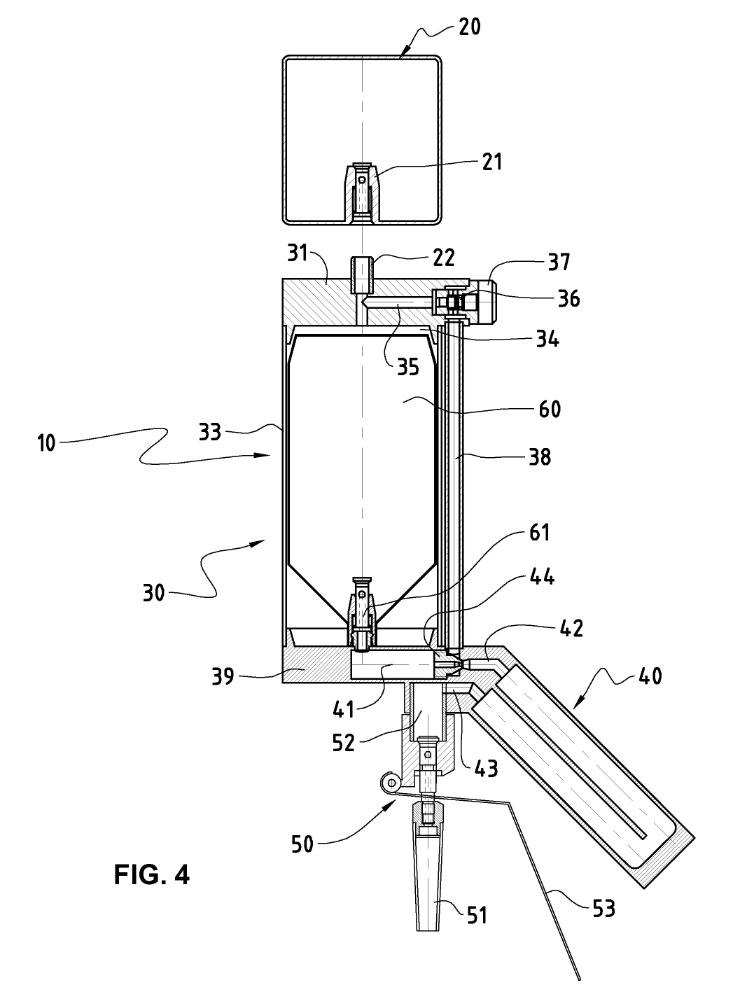

As is shown in FIGS. 2, 3, and 4, the device 10 can be easily disassembled and then subsequently reassembled. Thus, the fluid reservoir 60 can be easily removed and for example placed in a refrigerator. Because the liquids located therein are not contaminated by the propellant, this fluid reservoir 60 can be stored problem-free for longer periods of time. In addition, it is also possible to quickly replace one fluid reservoir 60 with another fluid reservoir 60 if several liquids are to be foamed.

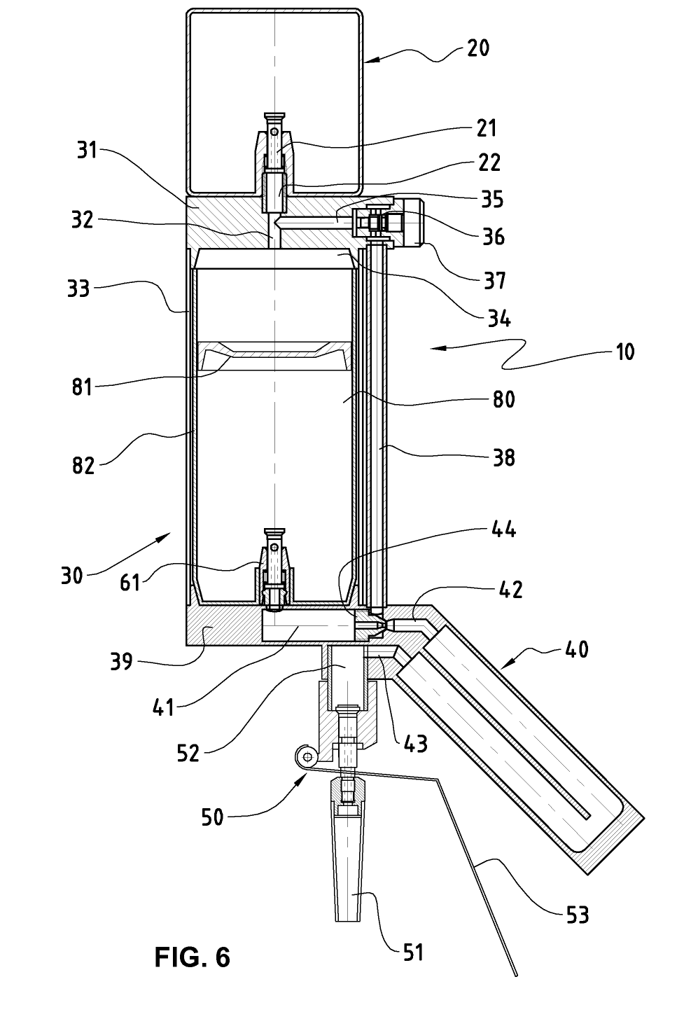

Another aspect of the invention, which only uses a rigid fluid reservoir 80 but which is otherwise based on exactly the same principle, is shown in FIG. 6. In this figure, the rigid fluid reservoir 80 comprises a displaceable piston 81 which can be displaced by the action of the propellant between the reservoir wall 82. As already described above, the pressure in the interior 34 of the housing 30 increases due to the influx of the propellant so that forces act on the piston 81 due to this increase in pressure. These forces cause the volume of the fluid reservoir 80 to decrease so that the liquids located therein are conveyed out of the fluid reservoir 80 and into the mixing device 40 as described above. But even in this case no contamination by the propellant of the liquid remaining in the fluid reservoir 80 takes place. The rigid fluid reservoir 80 can also be easily removed from the device 10 and replaced.

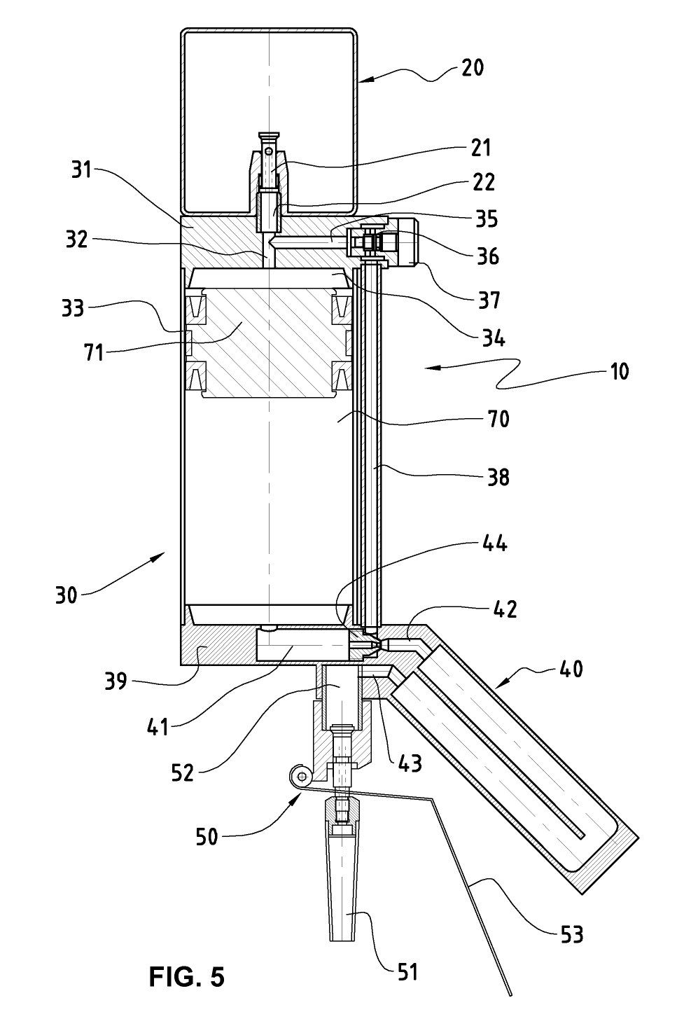

FIG. 5 shows a device 10 for foaming and delivery of liquids according to a second aspect of the present invention. In FIG. 5, the elements which already appear in previous figures have the same reference numbers so that they are not described in more detail at this point.

In contrast to the first aspect of the invention, there is no longer a separate fluid reservoir in the interior 34 of the housing 30. Instead, the liquids to be foamed are introduced directly into the interior 70 of the housing 30, and here again a piston 71 is provided so that an enclosed space 70 with the liquids to be foamed is created between the housing wall 33, the base 39 and the piston 71. When the propellant flows into the interior 34 of the housing 30, forces are again exerted due to the increase in pressure on the piston 71, wherein the volume of the fluid reservoir 70 decreases. The liquids located therein are similarly conveyed out of the fluid reservoir 70 and into the mixing device 40, as described above. Because of the sealing of the piston 71 against the housing wall 33, no contamination by the propellant of the liquids remaining in the fluid reservoir 70 takes place.

In conclusion, it is noted that the aspects described by way of example here represent only a selection of the possible realizations of the inventive concept and should in no way be considered limiting. A person skilled in the art will understand that further implementations of the invention and additional elements are possible without neglecting the essential features of the invention. In particular, other fastening, sealing, or controlling means, not mentioned, can be provided, by means of which the functional principle of the inventive device can be further improved.

1. A device for foaming and delivery of liquids comprising
a housing in which a fluid reservoir having the liquids to be foamed is provided,
a propellant reservoir for delivering a propellant, and
a dispensing mechanism for dispensing the foamed liquids, wherein a first part of the propellant can be transported out of the propellant reservoir through a first conduit to the fluid reservoir such that the liquid to be foamed can be conveyed out of the fluid reservoir and introduced into a mixing unit, a second part of the propellant can be introduced directly out of the propellant reservoir into the mixing unit through a second conduit, and the liquids conveyed out of the fluid reservoir into the mixing device by the propellant can be foamed, and
a control mechanism for adjusting a relative proportion between the first part of the propellant and the second part of the propellant.

2. A device according to claim 1, wherein a release mechanism is provided for actuating the release of the propellant out of the propellant reservoir.

3. A device according to claim 1, wherein the propellant reservoir is arranged removably on the housing and is connected to the housing via a pressure delivery mechanism.

4. A device according to claim 1, wherein the fluid reservoir is formed by the housing, wherein a piston is provided in the interior of the housing, which piston can be actuated by the first part of the propellant such that the liquid to be foamed is conveyed out of the reservoir.

5. A device according to claim 1, wherein the fluid reservoir is arranged removably in the interior of the housing and is connected via a transition valve to the mixing device.

6. A device according to claim 5, wherein the fluid reservoir is designed as a flexible fluid bag.

7. A device according to claim 6, wherein the flexible fluid bag is made from a synthetic material.

8. A device according to claim 5, wherein the fluid reservoir is formed as a rigid container, wherein a piston is provided in the interior of the container, which piston can be actuated by the first part of the propellant such that the liquid to be foamed is conveyed out of the container.

9. A device according to claim 1, wherein a locking mechanism is provided, during the opening of which the housing can be disassembled and reassembled during the locking of the same.

10. A device according to claim 1, wherein the propellant is compressed air.

11. A device according to claim 1, wherein the dispensing mechanism comprises a lever and/or a push button and or a nozzle actuation for controlling delivery of the foamed liquid.
